(19) United States
(12) Patent Application Publication
(10) Pub. No.: US 2004/0218663 A1
(43) Pub. Date: Nov. 4, 2004

(54) Radio transmission method and radio transmission system

(75) Inventors: Stefan Lindenmeier, Elchingen (DE); Anestis Terzis, Heidenheim (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/823,057

(22) Filed: Apr. 13, 2004

(30) Foreign Application Priority Data
Apr. 15, 2003 (DE) DE 103 17 549.0

(51) Int. Cl. H04B 1/69

(52) U.S. Cl. 375/131

(57) ABSTRACT

A radio transmission method is useful for transmitting or receiving control data and useful data. Prior to modulation onto a carrier frequency, the control data is transformed from a format adapted to a first radio transmission method into a format adapted to a second radio transmission method. In addition, a radio transmission system includes a baseband module and a high-frequency section, the baseband module and the high-frequency section being designed for radio standards which differ from one another, for transmitting useful data using control data. The radio transmission system also includes an adapter circuit which is suited for transforming the control data of the one radio standard into control data of the other radio standard.

Priority is claimed to German Patent Application Number DE 103 17 549.0, filed on Apr. 15, 2003, the entire disclosure of which was incorporated by reference herein.

The present invention is directed to a radio transmission method and to a radio transmission system.

### BACKGROUND

With the growing number of electronic terminals being used in daily life, the need has also increased in recent years for ways to exchange data among these terminals. Thus, for example, electronically stored address books in cellular phones, or electronic calendars in personal digital assistants (PDAs) are synchronized with one another or with computers via data interfaces. In the past, this was accomplished primarily by using cables, along with appropriate adapters or infrared interfaces. However, there are disadvantages associated with these methods. Thus, for example, when a cable-based approach is used for data synchronization, spatial flexibility is clearly limited. When working with infrared interfaces, the direct line-of-sight connection required between the participating devices is easily interrupted. As alternatives to the aforementioned possibilities, systems and methods based on radio transmission have established themselves in recent years. Two important examples of the radio transmission method for exchanging data among mobile electronic terminals are the wireless LAN in accordance with IEEE standard 802.11, and Bluetooth. The Bluetooth standard is described in detail in Bluetooth Specification 1.1, which is available for free on the Internet at https://www.bluetooth.org/. Bluetooth offers good flexibility for setting up ad-hoc networks and makes use of a frequency-hopping-spread-spectrum (FHSS) transmission method, in connection with short transmission ranges, to ensure a certain interference immunity and security against tapping. In this context, however, the individual components of the Bluetooth transmission system are tuned to one another in a way that makes the system only suited for use with the frequency-hopping-spread-spectrum transmission method mentioned above.

### SUMMARY OF THE INVENTION

An object of the present invention to devise a radio transmission method and a radio transmission system which will provide an expanded flexibility with respect to its individual method steps and its components, respectively.

The present invention provides a radio transmission method, control data and useful data being transmitted or received, wherein, prior to modulation onto a carrier frequency, the control data are transformed from a format adapted to a first radio transmission method into a format adapted to a second radio transmission method. For example, the first radio transmission method may be a frequency-hopping-spread-spectrum transmission method, and the second radio transmission method may be a CDMA transmission method, or vice versa. The present invention also provides a radio transmission system having a baseband module and a high-frequency section, wherein the baseband module and the high-frequency section are designed for radio standards which differ from one another, for transmitting useful data using control data and, in addition, an adapter circuit is provided which is suited for transforming the control data of the one radio standard into control data of the other radio standard.

In accordance with the radio transmission method of the present invention, control data and useful data are transmitted or received. In this context, the control data contain information, for example, that pertains to the transmission itself and its technical parameters. The useful data contain essentially the information itself that is to be transmitted, thus, for example, text, voice or image data. In accordance with the present invention, prior to modulation onto a carrier frequency, the control data are transformed from a format adapted to a first radio transmission method into a format adapted to a second radio transmission method, i.e., following such transformation, the control data contain information pertaining to the control data, which is required for generating a signal for the second radio transmission method.

In one first advantageous embodiment of the present invention, the control data contain, inter alia, information on the hopping frequencies to be used for a frequency-hopping spread spectrum transmission, i.e., frequencies at which the transmission is to take place, one after another in rapid sequence. In accordance with the present invention, prior to modulation onto a carrier frequency, these control data are transformed from a format adapted to the frequency-hopping spread spectrum transmission method into a format adapted to a CDMA transmission method, i.e., following such transformation, the control data contain information on the pseudorandom noise codes (PN codes), which is required for generating a signal for a CDMA transmission.

An alternative embodiment of the present invention provides a radio transmission system made up of a baseband module and a high-frequency section, the baseband module and the high-frequency section being designed for different radio transmission methods. To adapt the signals exchanged between the baseband module and the high-frequency section, an adapter circuit is also provided for conditioning the signals to be transmitted and received so as to enable them to be processed by the baseband module and the high-frequency section, respectively. In this context, the adapter circuit is particularly suited for transforming the control data in an effective manner. This arrangement makes it possible to advantageously combine system components which are designed for different transmission methods. Thus, the advantages of different radio transmission systems are united in one single radio transmission system.

In another advantageous embodiment of the present invention, the baseband module is designed for a frequency-hopping-spread-spectrum (FHSS) transmission system, and the high-frequency section for a code-division-multiple-access (CDMA) transmission system. In this context, the protocol concept for the baseband is devised for the frequency-hopping-spread-spectrum transmission system and the different hopping sequences associated therewith; thus, it may not be adopted, without being modified, for a CDMA high-frequency section. Therefore, the need exists to expand the communication between the baseband module and the high-frequency section. This is accomplished in the following manner: The channel of the baseband module containing the control data having the hopping sequence is not routed directly to the high-frequency section, but leads to the adapter circuit of the present invention. The adapter circuit then assigns a PN code to every specified hopping sequence. Thus, the output of the adapter circuit, which is linked to the high-frequency section, does not supply a hopping sequence, but rather a PN code. The high-frequency section used, which is essentially composed of a CDMA transceiver in accordance with the teaching of the present invention, then processes its data using the specified PN code, thereby enabling the stable CDMA transmission method, which is not susceptible to interference, to be used as a radio transmission method.

Conversely to the case described above, one advantageous variant of the present invention provides for the baseband module to be designed for a CDMA transmission system, and the high-frequency section for an FHSS transmission system.

If a baseband module designed for an FHSS transmission system is used, it has proven effective to use the baseband module of a Bluetooth transmission system. In this connection, the extremely flexible Bluetooth protocol stack may be used quite advantageously, in that many already existing protocols are considered, which may be used, as needed, in dependence upon the particular application.

In another advantageous embodiment of the present invention, various code sequences of the PN code to be used for the CDMA transmission system are stored in a memory unit of the adapter circuit. In the process, in dependence upon the hopping sequence applied to the input of the adapter circuit, suitably stored PN codes are selected via a selection logic and switched through to the output of the adapter circuit. This adapter circuit design ensures a rapid and simple assignment of hopping sequences to PN codes. This assignment, or mapping, is advantageously carried out using an assignment table, in which a corresponding PN code is stored for each hopping sequence that occurs. It is necessary that this assignment table be the same for the transmitting and the receiving system; in this context, specifically assigning hopping sequences to PN codes enables an additional encryption layer to be added, in contrast to directly extracting the PN code from the hopping sequence.

By using a controllable PN code generator, the need is eliminated for the memory unit. From the specified hopping sequence applied to the input of the adapter circuit, the PN code generator according to the present invention uses an algorithm to generate a PN code that is supplied to the output of the adapter circuit and, thus, to the high-frequency section. Since the algorithm may be flexibly selected, this specific embodiment of the present invention ensures that it is possible to first define the algorithm for code generation in an advanced state of development of the adapter circuit and, thus, to dynamically adapt it to the PN codes used in practice.

In another advantageous embodiment of the present invention, the adapter circuit is suited for generating the PN code to be used or the hopping sequences, in that a shift register is used. In this context, a short bit word Sᵢ is generated from the hopping sequence via a selection logic having an assignment table and is fed to the controllable code generator. On the basis of the individual bit statuses in bit word Sᵢ, the corresponding switch status is then determined for each memory cell in the shift register. It is beneficial in this context that, by using an n-bit long bit word, 2ⁿ−1 different PN codes are able to be generated, thereby enabling the memory required for generating the PN codes to be dramatically reduced.

By properly interconnecting the controllable PN code generator, the so-called M codes (maximum length codes) are able to be generated. If two specific M codes are then linked in an EXOR operation, the so-called gold codes result, which, because of their good cross correlation properties, may advantageously be used in CDMA transmission systems. To this end, the control circuit must drive each of the two shift-register code generators separately.

Another especially advantageous specific embodiment of the present invention provides for combining CDMA and frequency hopping with one another. In the process, control data from the already existing Bluetooth protocols may be used to generate the hopping sequences. In this case, the FHSS transmission system is not replaced by the CDMA transmission system by using the adapter circuit according to the present invention, but rather is merely expanded by the CDMA transmission system, in addition, frequency hopping still occurring. Combining the two radio transmission systems renders possible a greater signal-to-noise ratio, as well as an additional encryption possibility via an adjustable assignment between the hopping sequence and the code sequence. This yields a two-dimensional encryption, including the combination of n PN codes with m hopping sequences and, thus, n*m possible combinations. Thus, the encryption depth is increased by the factor n, over m in the case of the pure frequency hopping method. By using an FHSS and a CDMA transmission system at the same time, the transmission system according to the present invention makes it possible to transmit or to receive, so that the encryption depth, as well as the system's interference immunity and security against tapping are further enhanced.

The theoretical backgrounds of the CDMA and frequency hopping combination are explained in greater detail in the following. When working with a pure CDMA transmission system, the decoupling of the channels is determined by the maximum values of the cross correlation function between the PN codes used. If PN code c₁ is used for one channel, and PN code c₂ for the second channel, then three cross correlation functions are derived, which describe the channel interference in the receiver of channel 1 caused by a data sequence (thus by channel 2) to which PN code c₂ is assigned. In a receiving correlator, cross correlation function K₁₂₍₁₁₎ is derived for various time displacements τ between PN code c₁ and code c₂ always when a data sequence of logical sequence 1-1 is transmitted in channel 2. If a data sequence of logic sequence 0-0 is transmitted in channel 2, then cross correlation function K₁₂₍₀₀₎ is derived. In the case of logic sequences 0-1 and 1-0, functions K₁₂₍₀₁₎ and K₁₂₍₁₀₎ are derived. Assuming that c₁(t) and c₂(t) are a PN code sequence where

$${c}_{1 , 2} ( t ) = \{ \begin{matrix}{c}_{1 , 2} ( t ) & 0 < t < T \\ 0 & otherwise\end{matrix} \qquad ( 1 )$$

it then holds for the cross correlation functions that:

$$\begin{matrix}{K}_{12 ( 11 )} ( τ ) = {\int }_{0}^{τ} {c}_{1} ( t ) [ {c}_{2} ( t + T - τ ) + {c}_{2} ( t - τ ) ] ⅆ t & ( 2 ) \\ {K}_{12 ( 00 )} ( τ ) = {\int }_{0}^{τ} {c}_{1} ( t ) [ {\overline{c}}_{2} ( t + T - τ ) + {\overline{c}}_{2} ( t - τ ) ] ⅆ t & ( 3 ) \\ {K}_{12 ( 01 )} ( τ ) = {\int }_{0}^{τ} {c}_{1} ( t ) [ {\overline{c}}_{2} ( t + T - τ ) + {\overline{c}}_{2} ( t - τ ) ] ⅆ t & ( 4 ) \\ {K}_{12 ( 10 )} ( τ ) = {\int }_{0}^{τ} {c}_{1} ( t ) [ {c}_{2} ( t + T - τ ) + {\overline{c}}_{2} ( t - τ ) ] ⅆ t & ( 5 )\end{matrix}$$

The signal-to-interference ratio in the receiver is determined by the ratio of the autocorrelation level of the PN codes to the maximally attained value Kmax from the four cross correlation functions K₁₂₍₁₁₎, K₁₂₍₀₀₎, K₁₂₍₀₁₎ and K₁₂₍₁₀₎.

Kₘₐₓ=max[max[K₁₂₍₀₀₎]max[K₁₂₍₀₁₎]max[K₁₂₍₁₀₎]max[K₁₂₍₁₁₎]]tm (6)

If the PN codes are composed of n chip(s), then the maximum value is the greatest of 4n correlation values. Only a very small number of PN codes c₁ and c₂ is so constituted that all four cross correlation functions for all time displacements τ remain below a level which is low as compared to the autocorrelation level of the PN codes.

If at this point, in accordance with the present invention, each PN code sequence is transmitted in a hopping sequence suitable for it, then it holds that:

In one advantageous specific embodiment for short PN codes, the same hopping sequence may be used for all PN codes, a different frequency of the hopping sequence being used for each chip of the PN code. Two channels are then only still coupled when their hopping sequence proceeds time-synchronously, thus with a time displacement of τ=0. For this time displacement, it holds in accordance with equations (1) through (5):

K₁₂₍₀₁₎(0)=K₁₂₍₁₁₎(0) andK₁₂₍₁₀₎(0)=K₁₂₍₀₀₎(0) (7)

Thus, in this case, it holds for the maximum correlation value Kmax:

Kₘₐₓ=max[K₁₂₍₁₁₎(0),K₁₂₍₀₀₎(0)] (8)

At this point, the maximum value is thus merely still the greatest of two correlation values. Many PN codes are now easily found which attain low values for the maximum correlation value Kmax. Against this background, all those PN codes may now be selected whose cross correlation function at time displacement τ=O, has value Kmax=0 (or a low value as compared to the autocorrelation level). The number of PN codes which fulfill this condition, is many times greater than the number of PN codes, whose cross correlation function at all time displacements τ in accordance with equation (6) has the value 0 or a small value.

Thus, a multiplicity of PN codes having a small length may be used for decoupling many channels. Due to the small PN code length, the band spreading is distinctly less than in a pure CDMA system.

### BRIEF DESCRIPTION OF THE DRAWINGS

In the following, specific exemplary embodiments of the present invention and details pertaining to the invention are elucidated on the basis of a few figures, in which:

FIG. 1 shows a schematic, exemplary structure of a radio transmission system according to the present invention; FIG. 2 shows an exemplary adapter circuit according to the present invention, in its use for transforming a hopping sequence into a PN code sequence in the transmitting and receiving section of a communications link;

FIG. 3 shows an advantageous specific embodiment of the adapter circuit in which a memory unit is used;

FIG. 4 shows an advantageous specific embodiment of the present invention, in which a controllable PN code generator is used; and

FIG. 5 shows a preferred, detailed representation of a controllable code generator.

### DETAILED DESCRIPTION

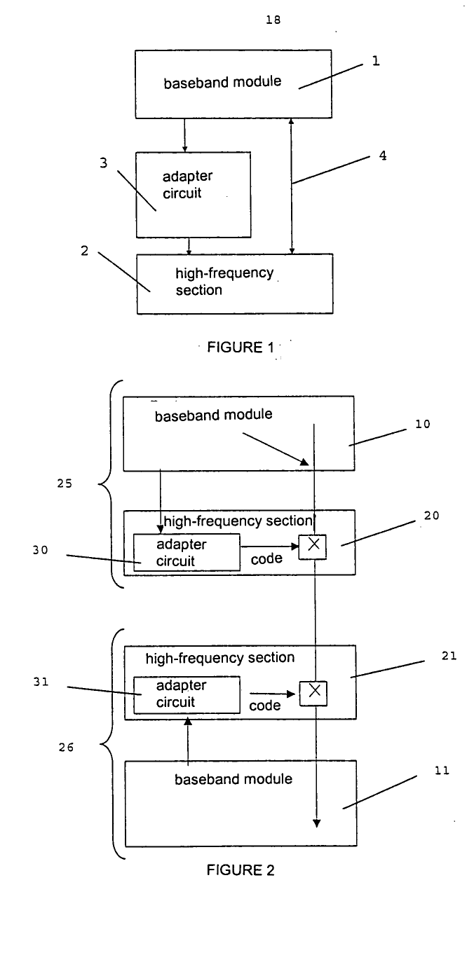

The transmission system according to the present invention illustrated in FIG. 1 has a baseband module 1, a high-frequency section 2, as well as an adapter circuit 3. Available at the output of baseband module 1 are useful and control data, which are fed via communications channel 4 and adapter circuit 3, respectively, to the high-frequency section. In the process, the control data, which specify the hopping sequence, are not routed directly to the high-frequency section, but are fed to adapter circuit 3 of the present invention. This circuit has the task of assigning a PN code to each specified hopping sequence. Thus, the output of adapter circuit 3 does not deliver a specified hopping sequence, but rather a specified PN code. High-frequency section 2, which, in one specific embodiment of the present invention, is constituted of a CDMA transceiver, must then process its data using the predefined PN code. In a Bluetooth transmission system, special hopping sequences are provided for each state of the participating devices. For each state, a special PN code is assigned to these special hopping sequences, using adapter circuit 3 according to the present invention. States such as inquiry (search for devices with which a connection can be established) or page (attempt to establish a connection to a known device) then receive a wake-up PN code, which is identical for all participants of the network, in place of the wake-up hopping sequences used in the frequency hopping spread spectrum methods. Thus, with the expansion described here, a frequency hopping spread spectrum method is adapted to the CDMA method. In the process, the already existing Bluetooth protocol stacks, which are present in the source code execution, may be advantageously used for the realization.

FIG. 2 illustrates the adapter circuit according to the present invention, in its use for transforming a hopping sequence into a PN code sequence in transmitting section 25 and in receiving section 26 of a communications link. In transmitting section 25 of the illustrated communications link, the useful data on the one hand, are fed directly to high-frequency section 20, and on the other hand, the control data, which contain the hopping sequence, are fed to adapter circuit 30, where the PN code for the subsequent transmission is generated from them. In receiving section 26, the hopping sequence contained in the communications data is read via high-frequency section 21 and baseband module 11 from the transmitted data and fed to adapter circuit 31, where the corresponding PN code is derived or selected from the hopping sequence.

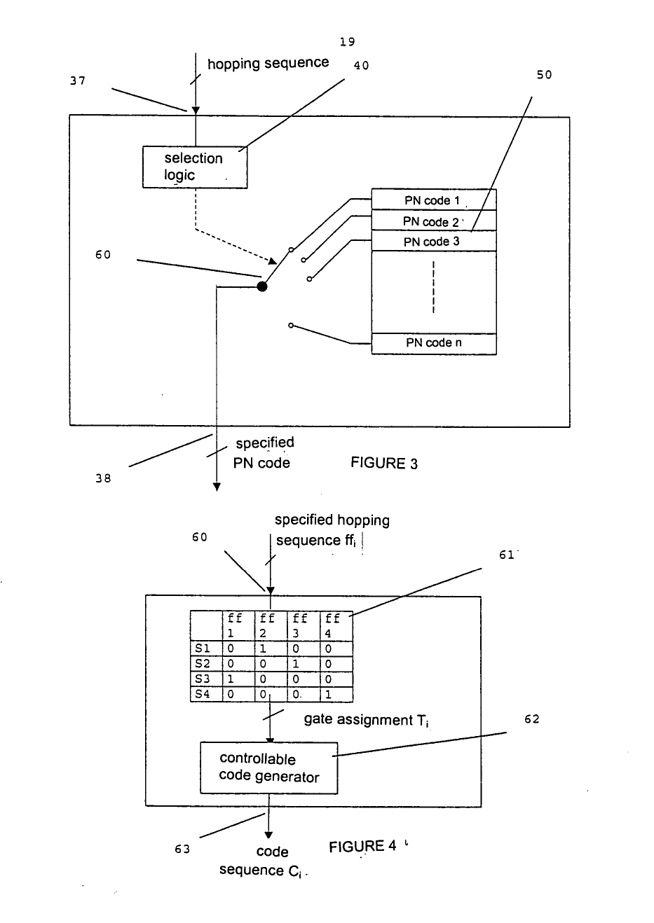

FIG. 3 shows an advantageous specific embodiment of the adapter circuit in which a memory unit is used. Available at input 37 of the adapter circuit is the specified hopping sequence that is fed to a selection logic 40, which assigns a PN code from memory unit 50 to the hopping sequence. The output of selection logic 40 controls a switch 60, which switches through the corresponding PN code to output 38 of the adapter circuit. In this context, the various PN codes, which are stored in memory unit 50, may differ in length. Input and output 37, 38 of the adapter circuit are each made up of a plurality of lines, the number of these lines corresponding to the PN code length.

FIG. 4 shows another advantageous specific embodiment of the present invention, in which a controllable PN code generator 62 is used. Here, PN codes are generated using suitable feedback shift registers, for example, the PN code generated being dependent on the type of feedback or feedback circuit. In the case of a controllable PN code generator 62, the feedback circuit is changed, and different PN codes are thereby generated. In the process, predefined hopping sequence ffᵢ enters at input 60 into the adapter circuit, and is fed to selection logic 61, which has an assignment table for the encryption. In assignment table 61, each hopping sequence ffᵢ is assigned a short bit word Sᵢ. Bit word Sᵢ is used for driving controllable code generator 62, which, as a result, emits code sequence Cᵢ via output 63 of the adapter circuit according to the present invention. If the code length of the PN code is 2ⁿ−1, then the length of the bit words to be stored must merely be n. This specific embodiment makes it possible to economize on memory capacity, since, in this case, the PN codes are not to be stored in entire length 2ⁿ−1, but merely short bit words of length n.

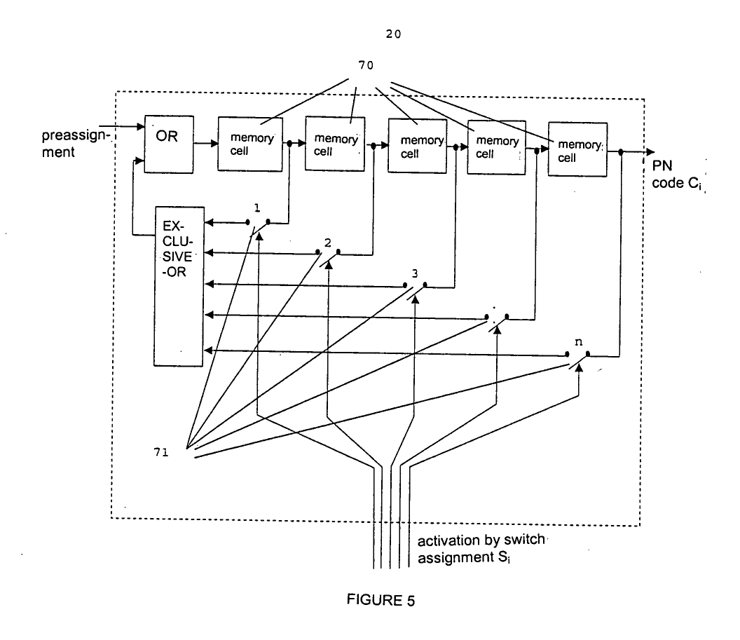

FIG. 5 is a detailed representation of controllable PN code generator 62. From the figure, it proceeds that the activation controls the shift register feedback. In the exemplary specific embodiment of FIG. 5, (shift register code/PN code generator having n memory cells 70), 2ⁿ−1 different PN codes may be generated by the activation. In the process, the circuit states at switches 71 are controlled via the bit statuses at the corresponding positions in bit word Sᵢ. For example, if the third position of the bit word is a logic “0”, then the third switch is open; if the fourth position is a logic “1”, then the fourth switch is closed. Moreover, still further memory cells and corresponding feedbacks may be switched as well, in order to generate longer PN codes.

What is claimed is:

1. A radio transmission method for sending or receiving control data and useful data, comprising:
transforming the control data from a first format adapted to a first radio transmission method into a second format adapted to a second radio transmission method; and
modulating the control data in the second format onto a carrier frequency.

2. The radio transmission method as recited in claim 1, wherein the first radio transmission method is a frequency-hopping-spread-spectrum transmission method, and the second radio transmission method is a CDMA transmission method.

3. The radio transmission method as recited in claim 1, wherein the second radio transmission method is a frequency-hopping-spread-spectrum transmission method, and the first radio transmission method is a CDMA transmission method.

4. A radio transmission system, comprising:
a baseband module for transmitting useful data using control data and configured for a first radio standard;
a high-frequency section for transmitting useful data using control data and configured for a second radio standard, the second radio standard being different from the first radio standard; and
an adapter circuit configured to transform the control data of one of the first and second radio standards into control data of the other of the first and second radio standards.

5. The radio transmission system as recited in claim 4, wherein the baseband module is configured for an FHSS transmission system and the high-frequency section is configured for a CDMA transmission system.

6. The radio transmission system as recited in claim 4, wherein the baseband module is configured for a CDMA transmission system and the high-frequency section is configured for an FHSS transmission system.

7. The radio transmission system as recited in claim 4, wherein the baseband module is configured for the Bluetooth standard.

8. The radio transmission system as recited in claim 4, wherein the adapter circuit includes a memory unit storing assignment instructions for a plurality of pseudorandom noise code sequences corresponding to a plurality of hopping sequences.

9. The radio transmission system as recited in claim 4, wherein the adapter circuit is configured to generate parameters for a pseudorandom noise code sequence from parameters for a hopping sequence.

10. The radio transmission system as recited in claim 4, wherein the adapter circuit is configured to generate parameters for a hopping sequence from parameters for a pseudorandom noise code sequence.

11. The radio transmission system as recited in claim 4, wherein the adapter circuit includes a shift register for generating at least one of parameters for pseudorandom noise code sequences and parameters for hopping sequences.

12. The radio transmission system as recited in claim 11, wherein the adapter circuit is suited for generating parameters for gold codes as pseudorandom noise code sequences.

13. The radio transmission system as recited in claim 4, wherein the high-frequency section is configured to realize the CDMA transmission method and the FHSS transmission method simultaneously within one transmission, in superimposed fashion.
